(19) United States
(12) Patent Application Publication
(10) Pub. No.: US 2008/0096451 A1
(43) Pub. Date: Apr. 24, 2008

(54) Acoustic and Thermal Shielding Device

(76) Inventor: Hans A. Haerle, Bopfingen (DE)

Correspondence Address: GRAY ROBINSON, P.A., P.O. Box 2328, FT. LAUDERDALE, FL, 33303-9998, US

(21) Appl. No.: 11/573,757

(22) PCT Filed: Aug. 13, 2005
(86) PCT No.: PCT/EP05/08831

§ 371 Date: Aug. 30, 2007

(30) Foreign Application Priority Data
Aug. 17, 2004 (DE) 10 2004 039 706.6

(51) Int. Cl. G10K 11/16

(52) U.S. Cl. 442/221; 264/45.3

(57) ABSTRACT

The invention relates to a device for acoustically and thermally shielding comprising a plate-shaped element. Said plate-shaped element comprises at least one layer of a woven metallic or plastic fabric having warp threads and weft threads, and said metallic or plastic tissue comprises pores. The warp threads and weft threads are not interlinked at their contact points by sintering.

### FIELD OF THE INVENTION

The invention relates to an acoustic and thermal shielding device with a plate-shaped element.

### BACKGROUND OF THE INVENTION

DE 91 07 484 U1 discloses a heat shield for shielding parts on a motor vehicle which carry exhaust gas, in which an insulating layer carried by an aluminum carrier sheet has an insert consisting of a regular aluminum netting, and at least one aluminum foil.

A further heat shield for motor vehicles is known from DE 199 39 482 A1. In this case, the heat shield is designed as a microperforated sheet metal molding, a cavity being present between the heat shield and an adjacent wall.

DE 38 21 468 C2 describes an insulating molding which has a flexible insulating mat and a sheetlike carrier covered for the most part with the insulating mat.

DE 81 30 562 U1 describes tubular knitted fabrics for mufflers, consisting of two aluminum tubes, one of which is coarse-mesh and the other fine-mesh.

DE 199 52 689 A1 discloses a sound insulating wall having a perforated wall and a rear wall which are connected to one another over their area by means of a multiplicity of spots of adhesive.

A further acoustic shielding element is known from EP 1 161 360 B1. In this case, a plate is provided, having a multiplicity of small perforations which, to achieve a saving of space, have a defined size and a defined arrangement.

DE 30 29 610 A1 describes a sound absorbing element which consists of a three-dimensional sheetlike textile structure with a metal covering on its fibers and/or threads. Furthermore, a method for producing such sound absorbing elements is described, in which woven or knitted plush fabrics are metallized.

However, all the known solutions are relatively special, in particular are only capable of achieving either a thermal or an acoustic protective action. A further disadvantage is the mostly highly complicated production of the known elements.

DE 103 45 575.2-53, having no priority date, describes an acoustic and thermal shielding device which has a plate-shaped element. The plate-shaped element has at least one layer of a woven metal fabric with warp threads and weft threads which are connected to one another by sintering at their contact points. This solution has the disadvantage that the production of the device entails relatively high costs.

### SUMMARY OF THE INVENTION

The object of the present invention is, therefore, to provide an acoustic and thermal shielding device which can be produced by simple and, in particular, cost-effective means and which can be used in a flexible way for shielding components with respect to thermal and acoustic actions.

This object is achieved, according to the invention, in that the plate-shaped element has at least one layer of a woven metal or synthetic fabric with warp threads and weft threads, the woven metal or synthetic fabric having pores.

The inventor has found, surprisingly, that the plate-shaped element of the acoustic and thermal shielding device according to the invention possesses, for most applications, sufficient strength, in particular against an independent loosening of the fabric, even when the highly cost-intensive step of sintering the contact points of the warp threads together with the weft threads is dispensed with. The overall device can thereby be produced much more cost-effectively, so that its chances on the market are increased considerably.

According to the invention, the plate-shaped element has a woven metal or synthetic fabric provided with pores, in which the pores act as a heat insulator on account of the air located in them and therefore offer thermal shielding. The heat insulation is thus induced by the pores within the woven metal or synthetic fabric which are filled with air or gas. In this case, the heat insulation of the fabric is the greater, the more pores there are in the fabric or the higher the porosity is. Better heat insulation is also obtained, the smaller the wire diameter is and the more plies the fabric has. The density of the fabric may also influence heat insulation, a lower density improving the heat insulation. Furthermore, the degree of heat insulation of the fabric can be increased by using a material with poor heat conduction for the warp and weft threads.

Moreover, the pores ensure an absorption of the sound entering these pores, so that the sound velocity energy of the sound is converted into heat energy and the sound is damped. The device according to the invention thus forms an acoustically active absorber. In this case, the flow resistance of the fabric is a function of the sound absorption, a higher flow resistance generating better sound absorption. If a fabric with good heat conductivity is used, the heat energy is quickly dissipated and thus absorbed within the pressure amplitude of the sound wave. A reduction in the pore size or in the spacing of the weft and/or warp threads likewise makes it possible to improve the sound absorption. In this case, the sound wave experiences, due to flow deflections within the fabric, a resistance which induces sound absorption. Those sound waves which do not penetrate into the fabric undergo diffuse reflection due to the warp and/or weft threads.

In this case, depending on requirements, a compromise is to be sought between heat insulation and sound absorption.

The particular advantage of using a fabric for the plate-shaped element is in this case that a fabric can be produced considerably more simply and more quickly than is the case, for example, with knitted goods. A further advantage arises in that very thin wires can be used for a fabric, so that it is possible to form extremely thin and therefore correspondingly flexible plate-shaped elements. This flexibility is advantageous when the device according to the invention is to be adapted to specific heat- and/or sound-radiating components, particularly in the engine space of a motor vehicle.

The device according to the invention may, of course, also be used when only acoustic or only thermal shielding is required.

In a highly advantageous development of the invention, there may be provision for the woven metal or synthetic fabric to have a thickness reduced by the application of a pressing force. Such a reduced thickness of the woven metal or synthetic fabric influences the porosity of the latter, a correspondingly reduced porosity being obtained in the case of a lower thickness. As a result, in turn, the sound resistance of the device according to the invention can be influenced, with the result that the latter can be adapted to various frequencies. Furthermore, due to a variation in the thickness of the woven metal or synthetic fabric, an increase in the contact area between the warp and weft threads is also obtained, so that the heat conductivity of the woven metal or synthetic fabric can also be influenced in this way. Moreover, by a pressing force being applied, the flow resistance of the fabric can also be set.

Improved corrosion protection for the device according to the invention can be achieved when the warp threads and/or the weft threads are in an advantageous embodiment galvanically treated or lacquered.

Alternatively, there may also be provision for the woven metal or synthetic fabric to be galvanically treated or lacquered.

Moreover, due to the galvanic treatment or lacquering of the woven metal or synthetic fabric, a further increase in strength of the latter can be achieved, since the contact points between the warp and weft threads are additionally stiffened thereby.

Advantageous uses of the device according to the invention include, by way of example, providing thermal shielding or acoustic shielding or both thermal shielding and acoustic shielding of components or systems which generate heat and/or sound. For example, the invention is well suited to provide thermal and/or acoustic shielding of a heat radiating and/or sound radiating component or system of a vehicle such as components located within the engine compartment of a motor vehicle or exhaust systems or exhaust system components such as mufflers and/or exhaust pipes of the exhaust system of a motor vehicle. The invention can also be used to provide effective thermal and/or acoustical shielding of engine covers and Helmholtz resonators.

Thermal and/or acoustic shielding devices can be produced according to a further aspect of the invention by forming a woven fabric of metal or synthetic material having warp threads and weft threads which are interwoven to define pores between the warp threads and weft threads without sintering the warp threads and weft threads together at points where they make contact with one another. By such a method, shielding devices of the type described above can be produced in a simple way.

It is particularly advantageous if the thickness of the woven metal or synthetic fabric is reduced by the application of a pressing force, in which case there may be provision, further, in this regard, for the pressing force to be applied to the woven metal or synthetic fabric by rolling.

The rolling of the woven metal or synthetic fabric has the considerable advantage, not mentioned above, that the fabric is joined together mechanically, in particular that the weft threads are pressed into the warp threads, and vice versa, so that a very good interlocking of the fabric is obtained and the latter acquires considerably improved cohesion and increased strength. This is important, above all, when the device according to the invention is to be shaped, after weaving, with relatively high degrees of shaping. Furthermore, rolling gives the fabric tension, with the result that the characteristic frequency of the latter can be set.

If, in a further advantageous embodiment of the invention, at least one structured roller is used for rolling the woven metal or synthetic fabric, a rough, bossed or wavy surface of the woven metal or synthetic fabric can be achieved, by means of which sound absorption and reflection can be influenced.

### BRIEF DESCRIPTION OF THE DRAWINGS

Exemplary embodiments of the invention are described below with reference to the drawings in which like reference numerals are used to designate like items and in which:

FIG. 1 shows a top view of a first embodiment of the thermal and acoustic shielding device according to the invention;

FIG. 2 shows a view according to the arrow II from FIG. 1;

FIG. 3 shows a section along the line III-III from FIG. 1;

FIG. 4 shows a top view of a second embodiment of the thermal and acoustic shielding device according to the invention;

FIG. 5 shows a section along the line V-V from FIG. 4;

FIG. 6 shows a section along the line VI-VI from FIG. 4;

FIG. 7 shows a weft thread of a rolled woven fabric in the demounted state;

FIG. 8 shows a warp thread of a rolled woven fabric in the demounted state;

FIG. 9 shows the passage of sound through a nonrolled woven fabric;

FIG. 10 shows the passage of sound through a rolled woven fabric;

FIG. 11 shows an illustration according to FIG. 3 in which a passage pore is illustrated in more detail;

FIG. 12 shows an illustration according to FIG. 2 in which a pore space is illustrated in more detail; and

FIG. 13 shows an example of a workpiece formed from the device according to the invention.

### DETAILED DESCRIPTION OF THE INVENTION

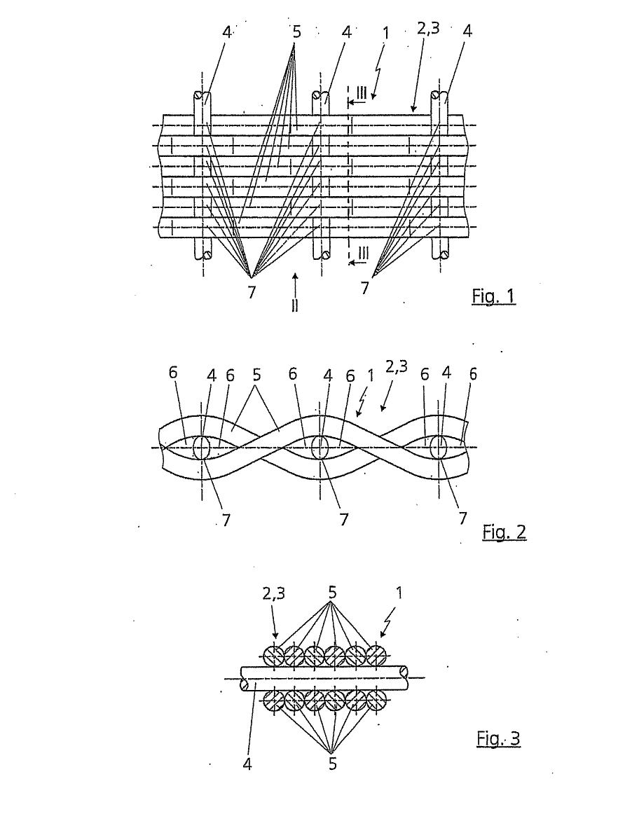

FIG. 1 shows a top view of an acoustic and thermal shielding device 1 with a plate-shaped element 2 which has a layer of a woven metal or synthetic fabric 3 or consists essentially of the woven metal or synthetic fabric 3. In addition to the woven metal or synthetic fabric 3, the plate-shaped element 2 may also have further layers, not illustrated. The woven metal or synthetic fabric 3 has warp threads 4 and weft threads 5 running essentially perpendicularly with respect to the warp threads 4. The woven metal or synthetic fabric 3 has, furthermore, pores 6 which are located between the warp threads 4 and the weft threads 5 and which can be seen in the illustration according to FIG. 2. The pores 6 of the woven metal or synthetic fabric 3 serve for converting the sound velocity energy of the sound impinging onto the plate-shaped element 2 into heat and thereby absorbing the sound waves.

In order to fulfill particular requirements, wires having a selected cross-sectional profile may be used as warp threads 4 and weft threads 5. In this case, if appropriate, different profiles may be employed.

The device 1 may be used, for example, in engine spaces of internal combustion engines for the acoustic shielding of sound-radiating components of any type. Further possibilities for using the device 1 occur inside mufflers and exhaust systems, as carrier material for engine covers, as carrier material for damping seals, as metal sheeting for Helmholtz resonators with and without additional damping, as Helmholtz resonators with foil covering, as a covering for Helmholtz resonators, as elastic resistance films, as heat insulation for baking ovens, toasters or other domestic appliances, as acoustic shielding for drive motors of washing machines and other domestic appliances, as sound absorbing material for compressors, for example in freezer cabinets, as the lining of flow ducts and intake ducts of turbines, motor vehicle engines, heating systems, compressors and the like, as the lining of mufflers, as an intermediate wall or inner tube of mufflers, as a covering layer for sound protection booths, sound walls or sound capsules, as acoustic shielding for drive motors of any type, as sound-absorbing housings or as plate and membrane absorbers.

In order to achieve an adaptation of the plate-shaped element 2 to the most diverse possible shapes of components to be shielded or to be produced from this, it is possible for the plate-shaped element 2 to be designed as a perforated sheet, as a slotted sheet or as expanded metal. Furthermore, the plate-shaped element 2 can be brought by forming, for example by deep drawing, into a shape adapted to the component to be shielded. The plate-shaped element 2 may be formed into a self-supporting component, and it is possible to stiffen the latter by means of beads and flanges. Moreover, the plate-shaped element 2 can be shaped into hoods, shells, pots, funnels and similar components by deep drawing, embossing and/or stamping. Profiles, such as, for example, hat profiles, box profiles or angle profiles, etc., can be formed from the plate-shaped element 2. Moreover, tubular profiles with a round, oval, rectangular, triangular or any other cross section can be produced from the plate-shaped element. The plate-shaped element may be folded, bossed, perforated or provided with rim holes. If a plurality of plies of this or even of different plate-shaped elements 2 are used, multiple-ply hoods or shells with different fabric densities and combinations can be produced from these. The plate-shaped element 2 may be coated or covered with other sound-absorbing media, such as, for example, ceramic fleece, basalt wool, organic wool, sheet metal foils or thick metal sheets. Furthermore, the plate-shaped element 2 or the components produced from it may be combined with microperforated foils, with perforated sheets or with expanded metals, in order to obtain better effects with regard to sound absorption. To break down the sound energy, there may also be provision for the plate-shaped element 2 or a component produced from this to be excited into oscillation by sound radiation and for the sound energy thus to be broken down.

In addition to the absorption of sound, the device 1 also serves for thermal shielding, particularly, again, for use on or in conjunction with components of internal combustion engines such as, for example, mufflers, exhaust lines, turbochargers, catalytic converters or other heat-radiating components. For this purpose, the pores 6 between the warp threads 4 and the weft threads 5 form air cushions which ensure the necessary thermal insulation. The heat conductivity of the plate-shaped element 2 arises due to the contact of the warp threads 4 with the weft threads 5 at respective contact points 7, the heat conductivity being the greater, the larger these contact points 7 are. Furthermore, the plate-shaped element 2, by being designed as a woven metal or synthetic fabric 3, has a large cooling surface, so that it is capable of rapidly dissipating the heat acting on it.

To produce the woven metal or synthetic fabric 3, the warp threads 4 and the weft threads 5 are interwoven by means of a weaving method known per se, such as, for example, a weaving method for producing a smooth braid or a twill weave, and in this case it is to be stressed that approximately all known weaving methods may be employed. By means of a specific type of weaving, different structures, for example a smooth and a rough structure, can be achieved on both sides of the fabric. Sound absorption can be influenced by the surface roughness of the fabric 3, and better sound absorption can be achieved by a rougher surface, since the sound waves are deflected to a greater extent. Further possible types of fabric are a plain weave, zigzag and alternating twill, five-shaft twill, twill braid, duplex, armor braid, broad-mesh twill braid or a fabric with metal fiber fleece, while the size of the pores 6 can be influenced by the choice of the type of fabric. Moreover, the warp threads 4 and/or the weft threads 5 may also be provided with a zinc or manganese phosphate layer before weaving. The surface roughness of the fabric 3 may be generated by phosphating or coating with ceramic or with a powder consisting of carbon, plastics or metal powder.

The material of the warp threads 4 and of the weft threads 5 may be, for example, a steel material, a copper material or an aluminum material. Further possible materials for the warp threads 4 and the weft threads 5 are, in principle, all noble, heavy and light metals, in particular also spring steel and high-grade steel and also light metal alloys. Furthermore, a plastic may also be used for the warp threads 4 and/or the weft threads 5. Preferably, the warp threads 4 and the weft threads 5 consist of the same material, but even different material may be employed, that is to say even a combination of plastic and metal is possible for the materials used.

If an aluminum material is used for the warp threads 4 and the weft threads 5, this results in a very light plate-shaped element 2, good heat conductivity and good formability also being afforded. Precisely where an aluminum material is concerned, it has been shown that the strength and cohesion of the fabric 3 can be increased considerably by a reduction in the thickness of the fabric 3, preferably by rolling in a calender roller or the like.

In the present exemplary embodiment, the warp threads 4 and the weft threads 5 have essentially the same diameter, that is to say maximum differences of 0.01-0.5 mm occur. Of course, the warp threads 4 and the weft threads 5 may also have considerably more different diameters. In principle, however, all wire thicknesses are possible.

In order to achieve a better cohesion of the warp threads 4 with the weft threads 5 at the contact points 7, the fabric 3 may be treated galvanically after production or after forming. In this way, for example, a fabric 3 consisting of a relatively simple and therefore cost-effective steel material can be galvanized, nickel-plated, copper-plated, aluminized or covered galvanically with another suitable material. Costs can thereby be saved, in that a less expensive material for the warp threads 4 and the weft threads 5 is used, which is subsequently provided with a galvanic coating. Furthermore, an additional stiffening of the fabric 3 is obtained in this way. Alternatively, even galvanically treated or lacquered warp threads 4 and weft threads 5 may be used for producing the fabric 3. In this case, the corrosion protection of the fabric 3 is then to the forefront and is, of course, also afforded by the galvanic coating of the entire fabric 3.

An alternative to a galvanic treatment is the lacquering of the woven metal or synthetic fabric 3, which may be adopted, above all, when the device 1 is exposed to no thermal stress. Preferably, for this purpose, the woven metal or synthetic fabric 3 is dipped into a lacquer bath. The lacquer in this case comes to lie particularly at the contact points 7 and is drawn into the corners of the pores 6 by capillary action, so that these are reduced in size. In this way, not only is the size of the pores 6 reduced, which, in turn, has an influence on sound absorption by the woven metal or synthetic fabric 3, but an increased rigidity of the overall woven metal or synthetic fabric 3 is also obtained due to the improved cohesion in the region of the contact points 7.

If, as described above, the plate-shaped element 2 is shaped, it is expedient to carry out galvanic treatment or lacquering after shaping, in order to prevent damage to the galvanic coating or the lacquer layer.

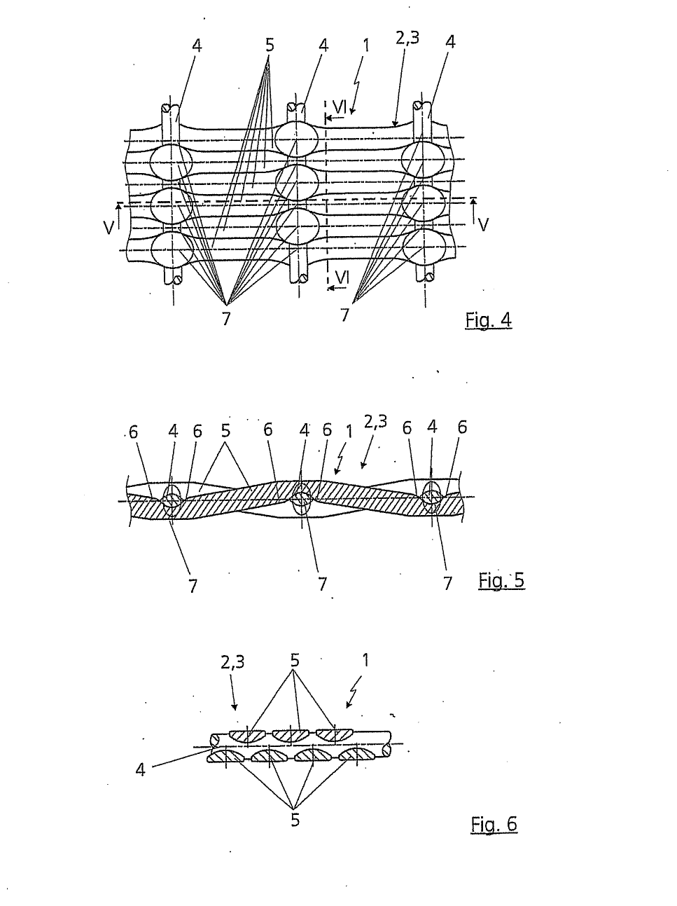

FIGS. 4 to 6 illustrate an embodiment of the device 1 according to the invention with the plate-shaped element 2 having the woven metal or synthetic fabric 3, in which the woven metal or synthetic fabric 3 has been rolled after weaving. In the top view according to FIG. 4, it can be seen that, as a result of this rolling, the contact points 7 between the warp threads 4 and the weft threads 5 are greatly flattened, so that, overall, a reduced thickness of the woven metal or synthetic fabric 3 is obtained. Alternatively, the pressing force may also be applied by pressing the woven metal or synthetic fabric 3 in a forging die. Furthermore, it is possible for the woven metal or synthetic fabric 3 to be press-welded by the application of the pressing force. For example, as a result of rolling, a fabric 3 which previously had a thickness of approximately 1.4 mm can be brought to a thickness of approximately 0.4 mm.

After the rolling or pressing of the fabric 3 to an appropriate thickness, the latter may be phosphated, lacquered or given a coating galvanically or in a melting bath, or a ceramic layer or carbon fibers may be applied to the fabric 3. A further possibility for treating the fabric 3 is that, after rolling or pressing to thickness, metallic fibers or powders are sprayed or sintered onto said fabric and may consist, for example, of the same material as the fabric 3 itself.

It may be gathered from the section according to FIG. 5 that the pores 6 between the warp threads 4 and the weft threads 5 have a considerably smaller cross section than in the embodiment according to FIGS. 1 to 3, thus leading to a variation in the sound absorption by the woven metal or synthetic fabric 3. Thus, depending on the degree of forming during rolling, the sound resistance of the woven metal or synthetic fabric 3 can be set.

It becomes clear from a comparison of FIG. 6 with FIG. 3 that the weft threads 5 have penetrated into the warp threads 4 on both sides due to rolling, both the warp threads 4 and the weft threads 5 having been deformed. It is clear that as a result of this mechanical joining operation, a considerably improved interlocking of the warp threads 4 with the weft threads 5 and therefore a considerably increased strength or rigidity of the woven metal or synthetic fabric 3 are obtained. As a result of the rolling or pressing of the fabric, a vertical and horizontal condensing of the fabric 3 occurs. Even in the rolled state, however, some, albeit considerably smaller movements are still possible between the warp threads 4 and the weft threads 5, so that sound energy can be broken down. Rolling or pressing of the fabric 3 may be carried out such that the plate-shaped element 2 acquires a sheetlike character, some porosity always remaining. The condensed fabric 3 can very easily be cut, stamped, crimped and deep-drawn, while a deep-drawing ratio of up to 1.8 can be achieved. Moreover, the fabric 3 may be further processed by means of various welding methods, such as, for example, spot and roll-seam welding, and all melt-welding methods. A further advantage of the rolling or pressing of the fabric 3 is to be seen in that, in the event of cutting to size into blanks, the outer wires or threads come loose only with difficulty or not at all, since condensing occurs due to rolling or pressing. Alternatively, rolling or pressing of the fabric 3 may even be dispensed with.

In order to achieve a structuring of the surface of the woven metal or synthetic fabric 3, one or even both rollers used for rolling the woven metal or synthetic fabric 3 may have a rough surface which is formed on the woven metal or synthetic fabric 3. As a result, the dispersion of the sound impinging onto the woven metal or synthetic fabric 3 can be varied. Before weaving, both the warp threads 4 and the weft threads 5 may be roughened in the radial and/or axial direction, in order to improve sound absorption. If the fabric 3 is cut to size, the edges of the blanks cut to size may be stiffened by the crimping of these, with the result that the risk of injury is reduced. Alternatively or additionally, it is also possible to fuse the edges of the blanks cut to size by severing cuts, for example by means of a laser beam.

The rigidity of the fabric 3 may be varied by the number and diameter of the warp threads 4. In principle, all the wire forms, such as, for example, round, angular, oval, etc., are possible for the warp threads 4 and the weft threads 5, while even different wire forms may be employed in one and the same fabric 3. In FIG. 2, it can be seen, further, that the pores 6 are largest on both sides of the warp threads 4. As seen from the weft threads 5, the largest through pore 6 is located between the upper and lower weft threads 5, which may likewise be gathered from FIG. 2. Thus, between the two weft threads 5 and the warp thread 4, illustrated in FIG. 2, a triangular space is formed, which, in the present patent application, is designated as a pore 6 and has proved to be especially sound-absorbing particularly in the types of fabric: plain braid, twill braid, duplex, betamesh and robuster. By the sound waves being deflected along the pores 6 on the warp threads 4, a Helmholtz effect occurs, by means of which the sound waves are absorbed. A greater shaping of the fabric 3 leads in this case to a thinner pore 6.

If a plurality of fabric plies are used, these may lie loosely one on the other or be in firm contact with one another. This firm contact may be made, for example, by welding, screwing, riveting or the like, while the individual plies may be arranged in a common frame.

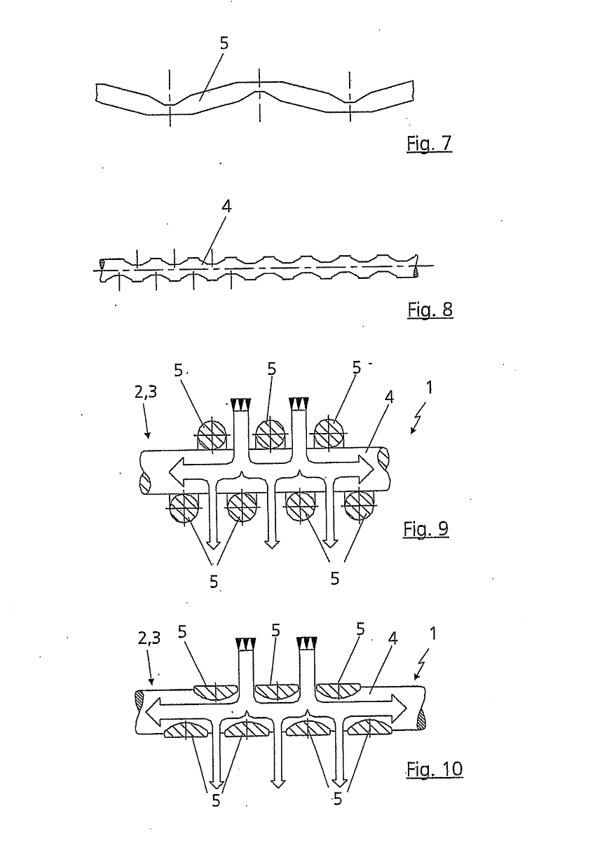

FIG. 7 illustrates a weft thread 5 of a fabric 3 rolled or pressed, as described above, in the demounted state, in which the deformations of the latter can be seen clearly. FIG. 8 shows a warp thread of the rolled fabric 3 in the demounted state. Here, too, the deformations can be seen clearly.

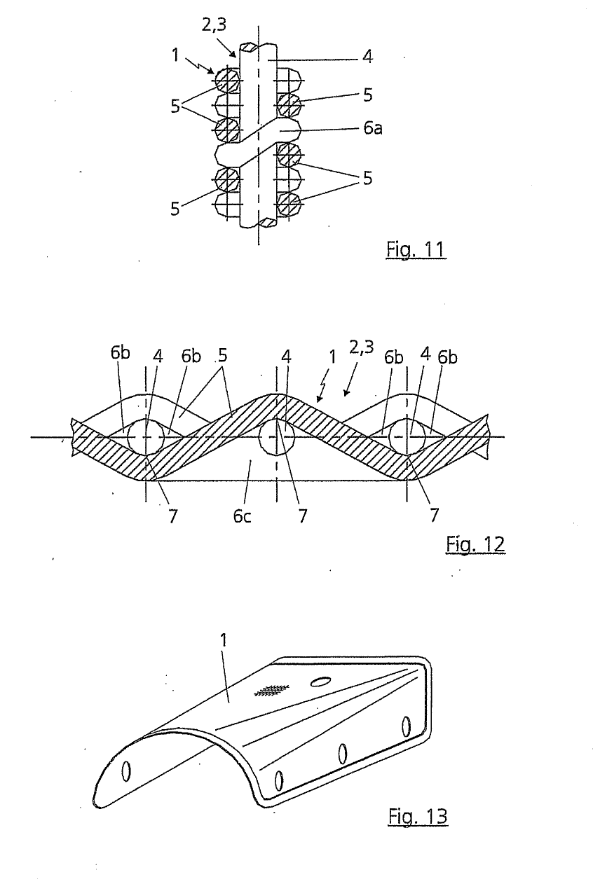

So that the passage of sound through a nonrolled fabric 3 with a porosity of approximately 50% can be compared with the passage of sound through a rolled fabric 3 with a porosity of approximately 25%, the passages of sound in both states are illustrated in FIGS. 9 and 10 by means of respective arrows. In this case, it can be seen that the sound is distributed to a greater extent by the rolled fabric 3 than by the nonrolled fabric 3.

In a similar illustration to FIG. 3, FIG. 11 shows by way of example a pore 6a having a throughflow in the vertical direction. By contrast, FIG. 12 illustrates a warp wire or horizontal pore 6b and a wedge-shaped pore space 6c absorbing the sound to the greatest extent.

As already mentioned above, the most diverse possible workpieces can be produced from the plate-shaped element 2 or from the device 1. Such an example of a workpiece formed from the device 1, to be precise a shielding sheet for an exhaust manifold, is illustrated in FIG. 13. This shielding sheet is attached at a specific distance from the exhaust manifold, preferably, to a component not connected to the exhaust manifold, in order to avoid the transmission of solid-borne sound.

While the foregoing constitute preferred embodiments of the invention according to the best mode presently contemplated by the inventor of making and carrying out the invention, it is to be understood that the invention is not limited to the particulars described above. In light of the present disclosure, various alternative embodiments and modifications will be apparent to those skilled in the art. Accordingly, it is to be recognized that changes can be made without departing from the scope of the invention has particularly pointed out and distinctly claimed in the appended claims as properly construed to include all legal equivalents.

1-20. (canceled)

21. An acoustic and thermal shielding device, comprising:
a plate-shaped element having at least one layer of a woven fabric having warp threads and weft threads, said fabric having pores, said warp threads and weft threads being of metal or a synthetic material and not being sintered together at points at which said warp threads and said weft threads contact one another.

22. The device as claimed in claim 21, wherein said fabric comprises a fabric whose thickness has been reduced by the application of a pressing force.

23. The device as claimed in claim 21, wherein said warp threads and/or said weft threads comprise threads which are galvanically treated or lacquered.

24. The device as claimed in claim 21, wherein fabric comprises a fabric which has been galvanically treated or lacquered.

25. The device as claimed in claim 21, wherein said warp threads and said weft threads are formed of a steel material.

26. The device as claimed in claim 21, wherein said warp threads and said weft threads are formed of an aluminum material.

27. The device as claimed in claim 21, wherein said warp threads and said weft threads are formed of a plastic.

28. A method of thermally and acoustically shielding a component which radiates heat and/or sound, said method comprising the steps of:
(a) forming a plate-shaped element having at least one layer of woven fabric having warp threads and weft threads, said warp threads and said weft threads being woven to define a plurality of pores within said fabric, said warp threads and said weft threads being of either metal or a synthetic material and not being sintered together at points at which said warp threads and said weft threads contact one another, and
(b) positioning said element in shielding relation to said component.

29. The method of claim 28 wherein said component comprises a component located in an engine compartment of a motor vehicle.

30. The method of claim 28 wherein said component comprises a component of a motor vehicle engine exhaust system.

31. The method of claim 30 wherein said element is positioned within an interior portion of said exhaust system.

32. The method of claim 28 wherein said element forms at least a portion of an engine cover.

33. The method of claim 28 wherein said component comprises a Helmholtz resonator.

34. A method for producing an acoustic and thermal shielding device, said method comprising the steps of:
(a) weaving warp threads and weft threads to form a fabric having pores, said warp threads and said weft threads being of a metal or synthetic material and not being sintered together at points at which said weft threads and said warp threads make contact with one another, and
(b) forming a piece of said fabric into a desired three-dimensional shape.

35. The method as claimed in claim 34, further comprising the step of reducing the thickness of fabric by applying a pressing force to said fabric.

36. The method as claimed in claim 35, wherein said pressing force is applied to said fabric by rolling.

37. The method as claimed in claim 36, wherein at least one structured roller is used for rolling the woven metal or synthetic fabric.

38. The method as claimed in claim 35, wherein said pressing force is applied by pressing said fabric in a die.

39. The method as claimed in claim 34, further comprising the step of galvanically treating said fabric.

40. The method as claimed in claim 39, wherein said forming step is carried out prior to galvanically treating said fabric.

41. The method as claimed in claim 32, further comprising the step of applying a lacquer to said fabric.

42. The method of claim 41 wherein said forming step is carried out prior to applying said lacquer.

43. The method as claimed in claim 35, wherein said pressing force is a force sufficient to press-weld said fabric.
